(19) United States
(12) Patent Application Publication
(10) Pub. No.: US 2024/0054498 A1
(43) Pub. Date: Feb. 15, 2024

(54) Systems, Methods and Computer Program Products for Contactless Payment Card Security at Unattended Type Terminals

(71) Applicant: Mastercard International Incorporated, Purchase, NY (US)

(72) Inventors: Ajay Sinha, Maharashtra (IN); Naveen Kumar Gupta, Maharashtra (IN); Lalit Manchanda, River Vale, NJ (US)

(21) Appl. No.: 18/365,666

(22) Filed: Aug. 4, 2023

(30) Foreign Application Priority Data
Aug. 5, 2022 (IN) 202211044958

(51) Int. Cl. G06Q 20/40; G06Q 20/34; G06Q 20/20

(52) U.S. Cl. CPC G06Q 20/409; G06Q 20/352; G06Q 20/204; G06Q 20/202; G06Q 20/4016

(57) ABSTRACT

The invention secures contactless payment cards against misuse at ‘unattended type’ terminal devices having near field communication capabilities. The invention involves receiving from a communication device a first unique identifier associated with a contactless payment card, and a second unique identifier associated with the communication device. Transmission of the first unique identifier and the second unique identifier from the communication device is implemented in response to the communication device detecting a contactless card tap event, and the communication device retrieving the first unique identifier from the contactless payment card. The invention involves selectively implementing one of a first payment authorization communication flow and a second payment authorization communication flow. The selective implementation is based on whether the first and second unique identifiers have been recorded within a database that stores combinations of payment card identifiers and communication device identifiers for payment transactions that have been previously successfully authorized.

### CROSS-REFERENCE TO RELATED APPLICATION

This application claims priority to India Patent Application No. 2022/11044958 filed on Aug. 5, 2022, the entirety of which is incorporated herein by reference.

### FIELD OF DISCLOSURE

The present invention relates to the domain of contactless payment card transactions, and more particularly to systems, methods and computer program products for securing contactless payment cards against misuse and unauthorized transactions at ‘unattended type’ terminal devices having near field communication capabilities.

### BACKGROUND TO DISCLOSURE

Modern processor bared communication devices (for example, mobile phones, computing devices etc.) are capable of being configured for several functions. Typical devices of this kind include capabilities for implementing data and voice communications, imaging, video capture, voice storage, audio reproduction and playback, image or video display, and the like. Touch based control functionality is also now a standard feature of such devices—which has been found to considerably simplify the user interface aspect of such devices. In addition, such devices are now commonly available with near field communication (“NFC”) capabilities.

Near field communication refers to a contactless-type short-range wireless communication that operates at a frequency bandwidth of 13.56 MHz. Near field communication comprises technology that requires a short distance of approximately 10 cm to transmit data between terminals equipped with an NFC transceiver. Near field communication is excellent in proximity, bi-directionality, and security, compared to other communication technologies, and has an advantage of establishing two way communication between terminals in 1/10 second or less without requiring complex pairing. As a result, near field communication technology is also now routinely incorporated within payment cards such as credit cards or debit cards—for enabling contactless payment transactions.

A now common type of electronic payment transaction involves initiating payment by presenting a contactless payment card (i.e. a payment card having NFC capabilities at a communication device (such as a mobile device) that also has NFC capabilities, for implementing a payment transaction.

FIG. 1 illustrates a conventional system environment 100 for implementing a contactless payment transaction for the purpose of payment for goods/services through an e-commerce server 114 which is configured to enable purchase of goods/services that are offered for purchase by an e-commerce platform. A contactless payment card 102 is brought in proximity with a communication device (e.g. a mobile phone) 104 having near field communication capabilities—and a payment transaction is initiated based on wireless communication between contactless payment card 102 and the communication device 104. The communication device 104 has implemented thereon a software application (for example a mobile software application) that is configured to enable execution of a contactless payment transaction in response to initiation of a NFC session between a contactless payment card and the communication device 104.

A payment instructions message comprising one or more of a contactless payment card identifier, payee account identifier, payment amount and a cryptogram generated by contactless payment card 102, is transmitted by communicator device 104 through network 106 to the e-commerce server 114, and onwards from the e-commerce server 114 to an acquirer network 108 (a data network maintained by an acquirer institution with which the payee account is maintained). Acquirer network 108 in turn transmits the payment instruction to issuer network 110 (a data network maintained by an issuer institution which has issued contactless payment card 102 to the corresponding payor) through payment network 112 (a data network maintained by an intermediary between the payee's acquirer and the payor's issuer—for example, Mastercard® or Visa®). Subject to successful authorization of the payment card (e.g. authorization based on validation of the cryptogram generated by contactless payment card 102), the requested payment is authorized and the payment amount is transferred from a payment account associated with contactless payment card 102 to the payee account. Confirmation of successful transaction completion may thereafter be transmitted back to the communication device 104.

It has however been found that communication devices 104 can be misused with the objective of carrying out unauthorized contactless payment card transactions, without the consent of the cardholder. Communication devices of the ‘unattended type’ are particularly susceptible to such misuse. Communication devices of the ‘unattended type’ comprise any communication device or terminal that has online transaction capabilities and that is attended or operated solely by the cardholder/person implementing the transaction. Examples of communication devices of the ‘unattended type’ include mobile phones, computing devices, personal digital assistants, laptops, tablets, smart TVs etc.—i.e. any device which is capable of enabling online/internet based payment transactions. A common example of a communication device of the ‘unattended type’ comprises a mobile phone having an e-commerce software application installed thereon, wherein the e-commerce software application enables payment transactions to be made for the purposes of purchasing goods or services, through an e-commerce platform or an e-commerce server.

Misuse of such communication devices occurs when a communication device of the “unattended type” (e.g. communication device 104) is brought within NFC communication range of a contactless payment card 102, without the knowledge of the cardholder, such that an NFC communication session is initiated between the contactless payment card 102 and the communication device 104 simply by the two entities being brought within communication range of each other. Typical tap-and-play mechanisms by most issuers permit for transactions that have a value lower than a specified threshold value (i.e. lower than a predefined CVM value) to be carried out by tapping a contactless payment card on a POS terminal having NFC capability, without triggering a second factor authentication process. Therefore, a malicious operator of a communication device of the “unattended type” can set up a purchase/payment transaction through a e-commerce software application installed on the communication device, and can surreptitiously bring the communication device close to a contactless payment card (for example, a contactless payment card in the pocket or wallet of a cardholder travelling in public transport) to unauthorizedly trigger a payment transaction using the contactless payment card.

There is accordingly a need to for securing contactless payment cards against misuse and unauthorized transactions at ‘unattended type’ terminal devices having near field communication capabilities.

### BRIEF DESCRIPTION OF THE ACCOMPANYING DRAWINGS

FIG. 1 illustrates a system environment for a conventional contactless payment transaction.

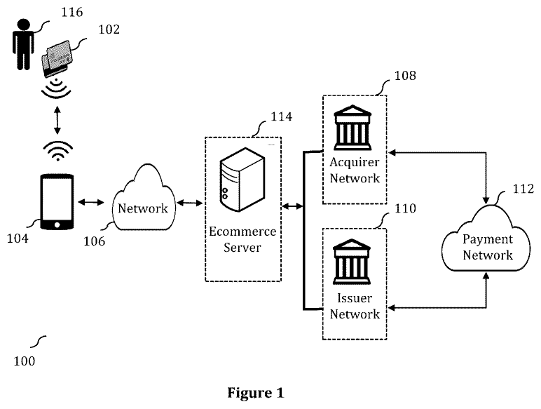

FIG. 2 illustrates a system environment for securing contactless payment cards against misuse and unauthorized transactions at ‘unattended type’ terminal devices, in accordance with the present invention.

FIG. 3 is a flowchart illustrating a method for securing contactless payment cards against misuse and unauthorized transactions at ‘unattended type’ terminal devices, in accordance with the present invention.

FIG. 4 is a communication flow diagram illustrating communication flow between system entities, for implementing the method of FIG. 3.

FIG. 5 is a flowchart illustrating a method for implementing a first payment authorization communication flow within the method of FIG. 3.

FIG. 6 is a communication flow diagram illustrating communication flow between system entities, for implementing the method of FIG. 5.

FIG. 7 is a flowchart illustrating a first embodiment of a method for implementing a second payment authorization communication flow within the method of FIG. 3.

FIG. 8 is a communication flow diagram illustrating communication flow between system entities, for implementing the method of FIG. 7.

FIG. 9 is a flowchart illustrating a second embodiment of a method for implementing a second payment authorization communication flow within the method of FIG. 3.

FIG. 10 is a communication flow diagram illustrating communication flow between system entities, for implementing the method of FIG. 9.

FIG. 11 is a flowchart illustrating a preferred embodiment of the method of FIG. 7.

FIG. 12 illustrates a first configuration of system components that may be implemented within the system environment of FIG. 2, for implementing the teachings of the present invention.

FIG. 13 illustrates a second configuration of system components that may be implemented within the system environment of FIG. 2, for implementing the teachings of the present invention.

FIG. 14 illustrates as exemplary computer system according to which various embodiments of the present invention may be implemented.

### SUMMARY

The invention provides systems, methods and computer program products for securing contactless payment cards against misuse and unauthorized transactions at ‘unattended type’ terminal devices having near field communication capabilities.

The invention provides a system for implementing a contactless payment card based payment transaction. The system comprises at least one processor implemented cloud POS server configured for (i) receiving from a communication device (a) a first unique identifier associated with a contactless payment card, and (b) a second unique identifier associated with the communication device, wherein the communication device has a software application implemented therewithin, and said software application is configured to implement payment transactions through a remote e-commerce server, and wherein transmission of the first unique identifier and the second unique identifier from the communication device is implemented in response to (1) the communication device detecting a contactless card tap event involving the contactless payment card and associated with a payment transaction being implemented between the software application the remote e-commerce server, and (2) the communication device retrieving the first unique identifier from the contactless payment card, and (ii) selectively implementing one of a first payment authorization communication flow and a second payment authorization communication flow, wherein the selective implementation is based on a determination whether a combination of the first unique identifier and the second unique identifier has been recorded within a database of records that stores combinations of payment card identifiers and communication device identifiers for payment transactions that have been previously successfully authorized.

In an embodiment, the system may be configured such that (i) the first payment authorization communication flow is implemented in response to determining that the combination of the first unique identifier, the second unique identifier has been previously recorded within a database of records that stores combinations of payment card identifiers and communication device identifiers for payment transactions that have been previously successfully authorized, and (ii) the first payment authorization communication flow comprises transmitting a payment instruction from the cloud POS server to a payment network for transaction implementation, independent of additional transaction authorization or transaction authentication communication flows.

The system may be configured such that transmitting the payment instruction from the cloud POS server to the payment network is preceded by the step of verifying that a transaction value associated the payment transaction being implemented between the software application the remote e-commerce server is less that an defined card verification method (CVM) threshold value.

In an embodiment, the system is configured such that (i) the second payment authorization communication flow is implemented in response to determining that the combination of the first unique identifier, the second unique identifier has not been previously recorded within a database of records that stores combinations of payment card identifiers and communication device identifiers for payment transaction that have been previously successfully authorized, and (ii) the second payment authorization communication flow comprises (a) triggering a transaction authorization communication flow or a transaction authentication communication flow, and (b) transmitting a payment instruction from the cloud POS server to a payment network for transaction implementation, in response to successful transaction authorization or transaction authentication.

In a system embodiment, the second payment authorization communication flow comprises triggering a transaction authentication communication flow, comprising the steps of (i) receiving from a lookup server, identification of an issuer associated with the contactless payment card, (ii) transmitting from the cloud POS server to an issuer server associated with the identified issuer, a transaction authorization request corresponding to the payment transaction, and any unique identifier associated with the contactless payment card, (iii) receiving from the issuer server, a transaction authorization confirmation message confirming that the payment transaction has been authorized, wherein the transaction authorization confirmation message is transmitted by the issuer server based on a result of call-response based authorization or authentication involving a cardholder associated with the contactless payment card, (iv) generating and storing in the database of records, a data record associating the combination of the first and the second unique identifiers, and (v) initiating implementation of the payment transaction, wherein the implementation involves transfer of the transaction amount from a payment account associated with the contactless payment card to a beneficiary payment account.

In another system embodiment, the second payment authorization communication flow comprises triggering a transaction authentication communication flow, comprising the steps of (i) receiving from the communication device one or more card tap event parameters associated with the contactless card tap event, (ii) receiving from a risk assessment server a transaction authorization confirmation message, (a) wherein the transaction authorization confirmation message is transmitted by the risk assessment server based on a security assessment of the contactless card tap event, wherein the security assessment is generated at the risk assessment server based on the received one or more card tap event parameters, and (b) the transaction authorization confirmation message is transmitted by the risk assessment server in response to the security assessment comprising a positive security assessment, (iii) generating and storing in the database of records, a data record associating the combination of the first and the second unique identifiers, and (iv) initiating implementation of the payment transaction where the implementation involves transfer of the transaction amount from a payment account associated with the contactless payment card to a beneficiary payment account.

In a further system embodiment, the contactless card tap event parameters comprise one or more of (i) communication device motion parameter(s) describing motion, movement, velocity or acceleration of the communication device, and (ii) location parameters identifying the location of the card tap event.

The system may be configured such that the step of transmitting from the cloud POS server to an issuer server associated with the identified issuer, a transaction authorization request corresponding to the payment transaction, and any unique identifier associated with the contactless payment card, is preceded by the step of assigning a zero-value to a session-specific CVM threshold value associated with a near-field-communication session that has been initiated by the card tap event detected at the communication device.

The invention a provides a method for implementing a contactless payment card based payment transaction. The method comprises implementing within a processor implemented cloud POS server, the steps of (i) receiving from a communication device (a) a first unique identifier associated with a contactless payment card, and (b) a second unique identifier associated with the communication device, wherein the communication device has a software application implemented therewithin, and said software application is configured to implement payment transactions through a remote e-commerce server, and wherein transmission of the first unique identifier and the second unique identifier from the communication device is implemented in response to (1) the communication device detecting a contactless card tap event involving the contactless payment card and associated with a payment transaction being implemented between the software application the remote e-commerce server, and (2) the communication device retrieving the first unique identifier from the contactless payment card, and (ii) selectively implementing one of a first payment authorization communication flow and a second payment authorization communication flow, wherein the selective implementation is based on a determination whether a combination of the first unique identifier and the second unique identifier has been recorded within a database of records that stores combinations of payment card identifiers and communication device identifiers for payment transactions that have been previously successfully authorized.

In an embodiment of the method, (i) the first payment authorization communication flow is implemented in response to determining that the combination of the first unique identifier, the second unique identifier has been previously recorded within a database of records that stores combinations of payment card identifiers and communication device identifiers for payment transactions that have been previously successfully authorized, and (ii) the first payment authorization communication flow comprises transmitting a payment instruction from the cloud POS server to a payment network for transaction implementation, independent of additional transaction authorization or transaction authentication communication flows.

In a further embodiment of the method, transmitting the payment instruction from the cloud POS sever to the payment network is preceded by the step of verifying that a transaction value associated the payment transaction being implemented between the software application the remote e-commerce server is less that an defined card verification method (CVM) threshold value.

In one embodiment of the method, (i) the second payment authorization communication flow is implemented in response to determining that the combination of the first unique identifier, the second unique identifier has not been previously recorded within a database of records that stores combinations of payment card identifiers and communication device identifiers for payment transactions that have been previously successfully authorized, and (ii) the second payment authorization communication flow comprises (a) triggering a transaction authorization communication flow or a transaction authentication communication flow, and (b) transmitting a payment instruction from the cloud POS server to a payment network for transaction implementation, in response to successful transaction authorization or transaction authentication.

In an embodiment of the method, the second payment authorization communication flow comprises triggering a transaction authentication communication flow, comprising the steps of (i) receiving from a lookup server, identification of an issuer associated with the contactless payment card, (ii) transmitting from the cloud POS server to an issuer server associated with the identified issuer, a transaction authorization request corresponding to the payment transaction, and any unique identifier associated with the contactless payment card, (iii) receiving from the issuer sever, a transaction authorization confirmation message confirming that the payment transaction has been authorized, wherein the transaction authorization confirmation message is transmitted by the issuer server based on a result of call-response based authorization or authentication involving a cardholder associated with the contactless payment card, (iv) generating and storing in the database of records, a data record associating the combination of the first and the second unique identifiers, and (v) initiating implementation of the payment transaction, wherein the implementation involves transfer of the transaction amount from a payment account associated with the contactless payment card to a beneficiary payment account.

In another embodiment of the method, the second payment authorization communication flow comprises triggering a transaction authentication communications flow, comprising the steps of (i) receiving from the communication device one or more card tap event parameters associated with the contactless card tap event, (ii) receiving from a risk assessment server a transaction authorization confirmation message, wherein the transaction authorization confirmation message is transmitted by the risk assessment server based on a security assessment of the contactless card tap event, wherein the security assessment is generated at the risk assessment server based on the received one or more card tap event parameters, and the transaction authorization confirmation message is transmitted by the risk assessment server in response to the security assessment comprising a positive security assessment, (ii) generating and storing in the database of records, a data record associating the combination of the first and the second unique identifiers, and (iii) initiating implementation of the payment transaction, wherein the implementation involves transfer of the transaction amount from a payment account associated with the contactless payment card to a beneficiary payment account.

In a method embodiment, the contactless card tap event parameters comprise one or more of (i) communication device motion parameter(s) describing motion, movement, velocity or acceleration of the communication device, and (ii) location parameters identifying the location of the card tap event.

In a specific embodiment of the method, the step of transmitting from the cloud POS server to an issuer server associated with the identified issuer, a transaction authorization request corresponding to the payment transaction, and any unique identifier associated with the contactless payment card, is preceded by the step of assigning a zero-value to a session-specific CVM threshold value associated with a near-field communication session that has been initiated by the card tap event detected at the communication device.

The invention also provides a computer program product for implementing a contactless payment card based payment transaction. The computer program product may be configured to implement any one or more of the methods described in this written description. In an embodiment, the computer program product comprises a non-transitory computer usable medium having a computer readable program code embodied therein, the computer readable program code comprising instructions for implementing the steps of (i) receiving from a communication device (a) a first unique identifier associated with a contactless payment card and (b) a second unique identifier associated with the communication device, wherein the communication device has a software application implemented therewithin, and said software application is configured to implement payment transactions through a remote e-commerce server, and wherein transmission of the first unique identifier and the second unique identifier from the communication device is complemented in response to (1) the communication device detecting a contactless card tap event involving the contactless payment card and associated with a payment transaction being implemented between the software application the remote e-commerce server, and (2) the communication device retrieving the first unique identifier from the contactless payment card, and (ii) selectively implementing one of a first payment authorization communication flow and a second payment authorization communication flow, wherein the selective implementation is based on a determination whether a combination of the first unique identifier and the second unique identifier has been recorded within a database of records that stores combinations of payment card identifiers and communication device identifiers for payment transactions that have been previously successfully authorized.

In various embodiments, the computer program product comprises computer readable program code configured to cause a processor to implement any of the method steps described below is the detailed description.

### DETAILED DESCRIPTION

The invention provides systems, methods and computer program products for securing contactless payment cards against misuse and against unauthorized transactions at ‘unattended type’ terminal devices having near field communication capabilities.

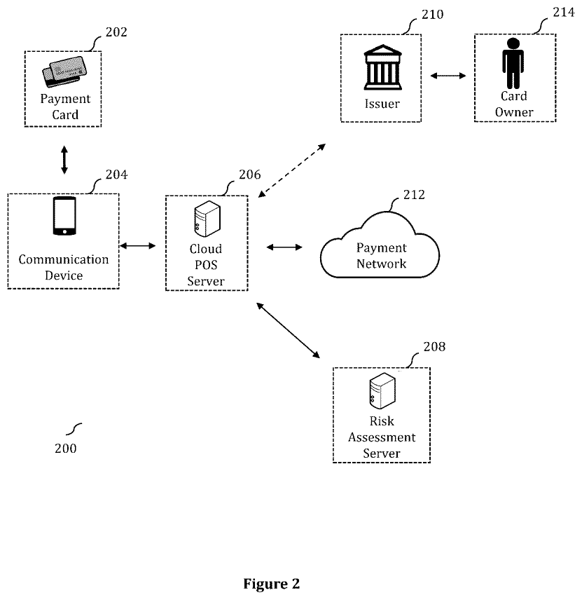

FIG. 2 illustrates a system environment for securing contactless payment cards against misuse and unauthorized e-commerce transactions or unauthorized payment transaction through ‘unattended type’ terminal devices.

System environment 200 comprises a communication device (e.g. a mobile phone) 204 having near field communication capabilities—wherein said communication device is of the ‘unattended type’ (i.e. any communication device or terminal that has online transaction capabilities and that is attended or operated solely by the cardholder/person implementing the transaction. Examples of a communication device of the ‘unattended type’ include without limitation, mobile phones, computing devices, personal digital assistants, laptops, tablets, smart TVs or any other device which is capable of enabling online/internet based payment transactions). Communication device 204 has implemented/installed therewithin a software application that enables payment transactions to be made to specified beneficiary payment accounts (for example an e-commerce platform payment account, or a merchant payment account). The communication device 204 has contactless communication capabilities—including any one or more of NFC capability, Bluetooth capability and/or wireless or WiFi communication capability, and is configured to be able to send and receive data over a contactless communication session initiated with any contactless payment card having corresponding contactless communication capabilities.

A contactless payment card 202 is brought in communication proximity (i.e. within contactless communication range) with communication device 204 having near field communication capabilities. A payment transaction initiation instruction is provided through the software application implemented within communication device 204. A payment transaction is thereafter initiated based on wireless communication between contactless payment card 202 and the communication device 204. In an embodiment, the software application implemented within the communication device 204 may be configured to enable execution of a contactless payment transaction in response to initiation of a NFC session between a contactless payment card 202 and the communication device 204.

A payment instruction comprising one or more of the contactless payment card identifier, payee account identifier, payment amount and a cryptogram generated by contactless payment card 202, is transmitted by communication device 204 through a communication network to a cloud point-of-sale (POS) server 206 that is configured to receive payment instructions forwarded by the software application within communication device 204 and to initiate a payment transaction based on the received payment instructions.

The cloud POS server 206 may be located in any one of several locations—including without limitation, the communication device 204 itself, or an e-commerce server, or any offer server that is located remote to the communication device 204. The cloud POS server 206 is configured to determine whether the payment transaction requires further authentication/authorization, and if so, to initiate an authorization process flow or an authentication process flow involving an issuer 210 of the contactless payment card 202 and a card owner/cardholder 214 associated with the contactless payment card 202. The cloud POS server 206 is additionally configured for communication with a risk assessment server 208, which is configured to assess or determine whether individual payment transactions require further authentication/authorization. In various embodiment, the cloud POS server 206 may be implemented within a single computing device or single processing entity, or within a centralized processing device such as a server within a data center (e.g. a ‘cloud-based’ computing device) or by implementing the functionality of the cloud POS server 206 using the processing capabilities of a plurality of computing devices which may be distributed across a network (e.g. located in different data centers).

Payment network 212 is a data network maintained by an intermediary between the payee's acquirer and the payor's issuer (for example, Mastercard® or Visa®). In the event a payment transaction is determined as not requiring authentication/authorization, or in response to successful authentication/authorization the cloud POS server 206 is configured to initiate the requested payment transaction involving the contactless payment card 202, through payment network 212. The payment network 212 serves as an intermediary and enables transfer of the transaction payment amount from a payment account corresponding to the contactless payment card 202, to a payee account that corresponds to the specified payee account identifier. In various embodiment, the payment network 212 may be implemented within a single computing device or single processing entity, or within a centralized processing device such as a server within a data center (e.g. a ‘cloud-based’ computing device) or by implementing the functionality of the payment network 212 using the processing capabilities of a plurality of computing devices which may be distributed across a network (e.g. located in different data centers).

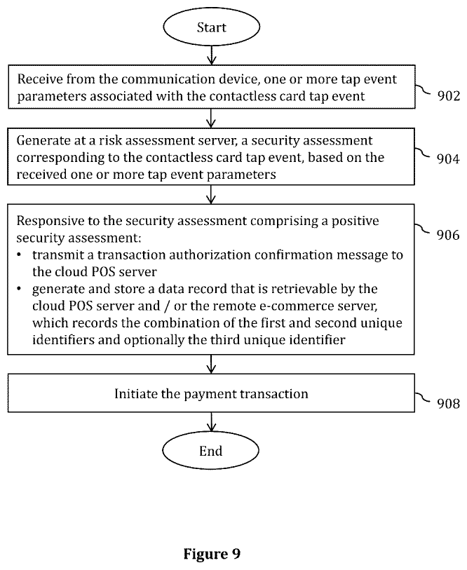

Specific methods implemented by the various system components within system environment 200, for the purposes of implementing the present invention are discussed in more in convection with FIGS. 9 to 11 below.

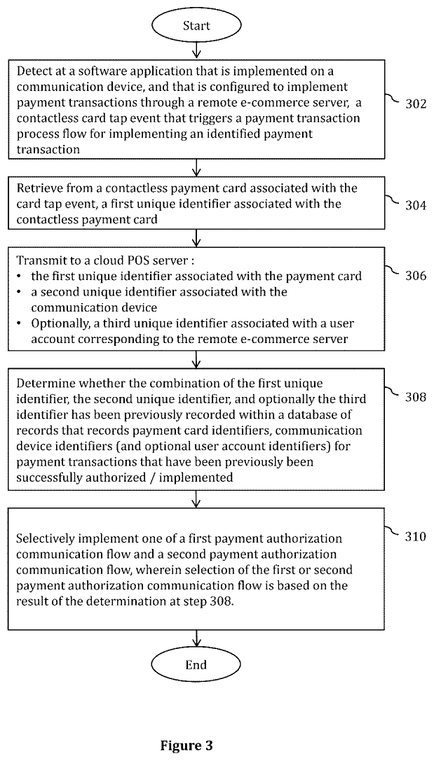

FIG. 3 is a flowchart illustrating a method for securing contactless payment cards against misuse and unauthorized transactions at ‘unattended type’ terminal devices. In an embodiment, the method of FIG. 3 may be implemented within system environment 200 of FIG. 2.

Step 302 comprises detecting at a software applications (that is implemented on a communication device 204, and that is configured to implement payment transactions through a remote e-commerce server), a contactless card tap event. The contactless card tap event is detected at communication device 204 and triggers a payment transaction process flow for implementing an identified payment transaction. The communication device may compare a communication device having contactless communication capabilities, and in a specific embodiment may comprise communication device 204 within system environment 200. In a particular embodiment, the communication device may comprise an ‘unattended’ type communication device which has online transaction capabilities and that is attended or operated solely by the cardholder/person implementing the transaction. The software application implemented on the communication device may comprise an e-commerce software application or a payment wallet application that is configured to enable online payment transactions involving a contactless payment card and a remote e-commerce server.

The contactless card tap event may comprise a card tap event involving a contactless payment card 202 of the kid illustrated within system environment 200.

Step 304 comprises retrieving from a contactless payment card associated with the card tap event, a first unique identifier associated with the contactless payment card. In an embodiment, the first unique identifier may comprise a payment account number or a hash of a payment account number associated with the contactless payment card.

Step 306 comprises transmitting from the communication device to a cloud POS server (for example cloud POS server 206 within system environment 200): the first unique identifier associated with the payment card; a second unique identifier associated with the communication device; and optionally, a third unique identifier associated with a user account corresponding to the remote e-commerce server.

The second unique identifier associated with the communication device may comprise any unique device identifier corresponding to the communication device—for example, a MAC address, IMEI number, or any other unique hardware or software identifier. The optional third unique identifier comprises any unique identifier corresponding to a user account at the remote e-commerce server, through which user account the payment transaction with the e-commerce platform is being entered into—for example, a login ID.

Step 308 comprising determining whether the combination of the first unique identifier, the second unique identifier, and optionally the third unique identifier has been previously recorded within a database of records that stores combinations of payment card identifiers, communication device identifiers (and optionally, user account identifiers) for payment transactions that have been previously successfully authorized or authenticated or implemented. In an embodiment, step 308 may be implemented at cloud POS server 206.

The objective of implementing step 308 is to ascertain whether the contactless payment card that is associated with the card tap event detected at step 302 has been successfully used for a previous payment transaction implemented through the same communication device. Step 308 ascertains this by checking whether the first unique identifier (corresponding to the contactless payment card) and the second unique identifier (corresponding to the communication device) have been previously mapped or correlated together in response to a prior successfully authorized/authenticated/implemented payment transaction involving the same contactless payment card and the same communication device. Confirmation that the contactless payment card—communication device pair has been previously used for a successful payment transaction, serves as an indication that the present transaction is also a valid one, and is not an instance of misuse or of an unauthorized payment transaction.

In embodiments where step 308 comprises determining whether the combination of the first unique identifier, the second unique identifier, and also the third unique identifier has been previously recorded within a database of records that stores payment card identifiers, inclusion of the third identifier is the determination provides additional security. This is for the reason that consideration of the third unique identifier enables a determination whether the same contactless payment card has been used for a payment transaction involving the same communication device, and through the same user account at the e-commerce server. This serves as an even more specific indication that the present transaction is also a valid one, and is not an instance of misuse or of an unauthorized payment transaction.

Step 310 comprises selectively implementing one of a first payment authorization communication flow and a second payment authorization communication flow, wherein selection of the first or second payment authorization communication flow is based on the result of the determination at step 308.

In an embodiment of step 310, responsive to step 308 resulting in a determination that the combination of the first unique identifier, the second unique identifier, and optionally the third identifies has been previously recorded, the first payment authorization communication flow comprises transmitting the payment instruction from the cloud POS server (e.g. cloud POS server 206) to a payment network (e.g. payment network 212) for transaction implementation, without requiring (or independent of) further transaction authorization/authentication or any second factor authentication communication flows.

In an embodiment of step 310, responsive to step 308 resulting in a determination that the combination of the first unique identifier, the second unique identifier, and optionally the third identifier has not been previously recorded, the second payment authorization communication flow comprises triggering a transaction authorization or a transaction authentication communication flow (for example, a second factor authentication process flow) and subsequently transmitting the payment instruction to a payment network for transaction implementation only if the transaction authorization/authentication process flow results in successful authorization/authentication of the payment transaction.

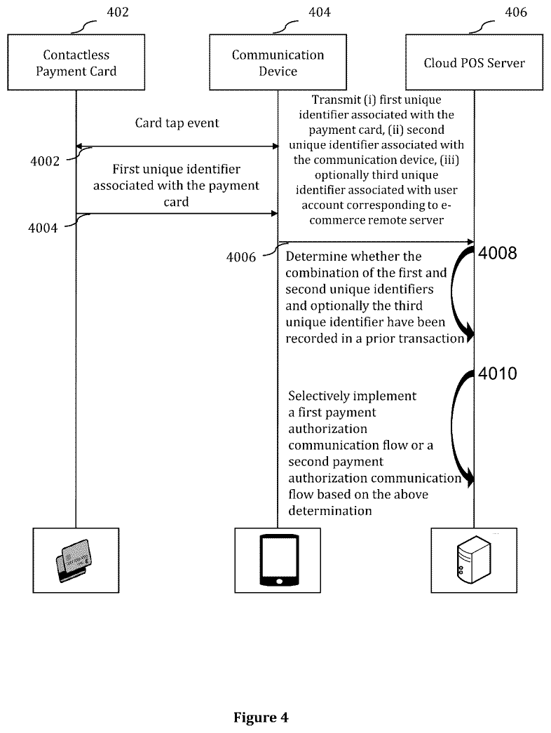

FIG. 4 is a communication flow diagram illustrating communication flow between system entities, for implementing the method of FIG. 3.

Step 4002 comprises implementing a card tap event involving contactless payment card 402 and communication device 404. The communication device 404 may comprise a communication device having contactless communication capabilities, and in a specific embodiment may comprise an embodiment of communication device 204 within system environment 200. In a particular embodiment, the communication device 404 may comprise an ‘unattended’ type communication device which has online transaction capabilities and that is attended or operated solely by the cardholder/person implementing the transaction. Communication device 404 may have a software application implemented thereon, which software application comprises an e-commerce software application or a payment wallet application that is configured to enable online payment transactions involving a contactless payment card and a remote e-commerce server.

The contactless payment card may comprise an embodiment of contactless payment card 202 of the kind illustrated within systems environment 200.

Step 4004 comprises receiving or retrieving from contactless payment card 402 associated with the card tap event, a first unique identifier associated with the contactless payment card 402. In an embodiment, the first unique identifier may comprise a payment account number or a hash of a payment account number associated with the contactless payment card 402.

Step 4006 comprises transmitting from the communication device 404, to a cloud POS server 406 (which may in an embodiment comprise as embodiment of cloud POS server 206 of the type found within system environment 200): the first unique identifier associated with the contactless payment card 402; a second unique identifier associated with the communication device 404; and optionally, a third unique identifier associated with a user account corresponding to a remote e-commerce server.

The second unique identifier associated with the communication device may comprise any unique device identifier corresponding to the communication device—for example, a MAC address, or IMEI number, or any other unique identifier. The optional third unique identifier comprises any unique identifier corresponding to a user account at the remote e-commerce server, with through which user account the payment transaction with the e-commerce platform is being entered into (e.g. a login ID).

Cloud POS server 406 thereafter determines at step 4008 whether the combination of the first unique identifier, the second unique identifier, and optionally the third unique identifier has been previously recorded within a database of records that records payment card identifiers, communication device identifiers (and optionally user account identifiers) for payment transactions that have been previously successfully authorized/authenticated/implemented. Confirmation that the contactless payment card—communication device pair (or the triple comprising the contactless payment card—communication device—user account) has been previously used for a successful payment transaction/authentication/implementation, serves as an indication that the present transaction is also a valid one, and is not an instance of misuse or of an unauthorized payment transaction.

Based on this determination, cloud POS server 406 then at step 4010 selectively implements one of a first payment authorization communication flow and a second payment authorization communication flow.

In an embodiment the first payment authorization communication flow is implemented responsive to a determination that the combination of the first unique identifier, the second unique identifier, and optionally the third unique identifier has been previously recorded within a database of records that stores payment card identifiers, communication device identifiers (and optionally user account identifiers) for payment transactions that have been previously successfully authorized/authenticated/implemented. The first payment authorization communication flow comprises transmitting the payment instruction from the cloud POS server 406 to a payment network (e.g. payment network 212) for transactions implementation, without requiring further transaction authorization/authentication or any second factor authentication.

In another embodiment, the second payment authorization communication flow is implemented responsive to a determination that the combination of the first unique identifier, the second unique identifier, and optionally the third unique identifier has not been previously recorded within a database of records that records payment card identifiers, terminal device identifiers (and optionally, user account identifiers) for payment transactions that have been previously successfully authorized/authenticated/implemented. The second payment authorization communication flow comprises triggering a transaction authorization/authentication process flow (for example, a second factor authentication process flow) and subsequently transmitting the payment instruction to a payment network for transaction implementation only if the transaction authorization/authentication process flow results is successful authentication of the payment transaction.

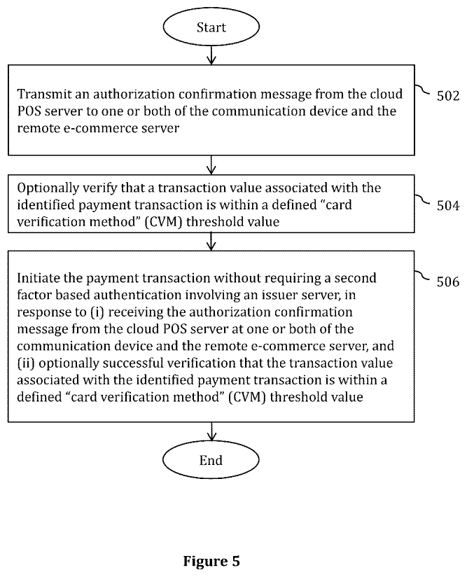

FIG. 5 is a flowchart illustrating a method for implementing a first payment authorization communication flow within the method of FIG. 3. In an embodiment, the method of FIG. 5 is implemented in response to a determination at step 308 (of the method of FIG. 3) that the combination of the first unique identifier, the second unique identifier, and optionally the third unique identifier has been previously recorded/mapped within a database of records that stores payment card identifiers, communication device identifiers (and optionally user account identifiers) for payment transactions sat have been previously successfully authorized/authenticated/implemented. In an embodiment, the method of FIG. 5 is initiated at or implemented within cloud POS server 206, 406.

Step 502 comprises transmitting an authorization confirmation message from the cloud POS server (e.g. cloud POS server 206) to one or both of the communication device (e.g. communication device 204) and the remote e-commerce server.

Step 504 comprises optionally verifying that a transaction value associated with the identified payment transaction is within a defined “card verification method” (CVM) threshold value. A CVM threshold value is a value associated with a payment card, which represents the maximum payment transaction value that can be carried out for such payment card, without having to implement a secondary transaction verification/identity authentication process flow (for example, without having to implement a second factor authentication process flow).

Step 506 comprises initiating the payment transaction without requiring a second factor based authentication involving an issue server, in response to (i) receiving the authorization confirmation message from the cloud POS server at one or both of the communication device and the remote e-commerce server, and (ii) optionally, successful verification that the transaction value associated with the identified payment transaction is within a defined “card verification method” (CVM) threshold value.

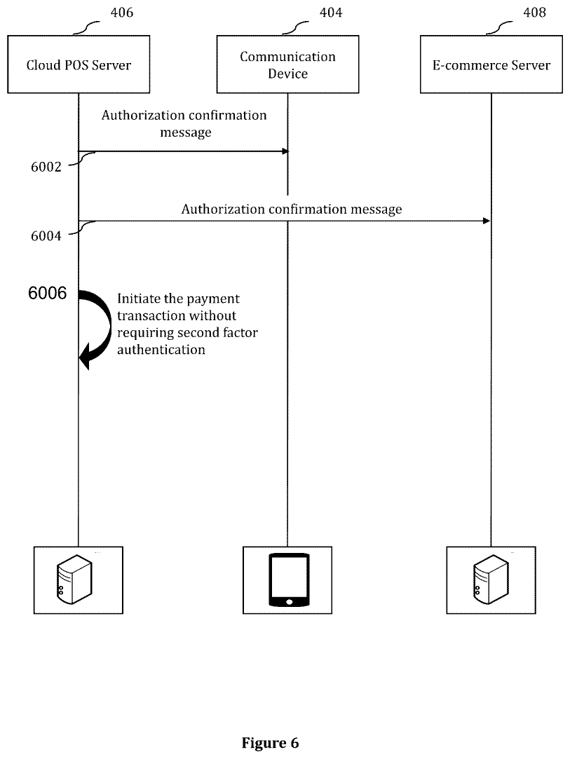

FIG. 6 is a communication flow diagram illustrating communication flow between system entities, for implementing the method of FIG. 5.

Step 6002 comprises transmitting an authorization confirmation message from cloud POS server 406 to communication device 404. Step 6004 comprises transmitting an authorization confirmation message from cloud POS server 406 to remote e-commerce server 408.

Steps 6002 and 6004 may be followed by the optional step (not shown) of verifying that a transaction value associated with the identified payment transaction is within a defined “card verification method” (CVM) threshold value.

Thereafter, cloud POS server 406 initiates at step 6006 the payment transaction without requiring a second factor based authentication involving an issuer server, is response to (i) receiving the authorization confirmation message from cloud POS platforms 406 at one or both of the communication device 404 and the remote e-commerce server 406, and (ii) optionally, successful verification that the transaction value associated with the identified payment transaction is within a defined “card verification method” (CVM) threshold value.

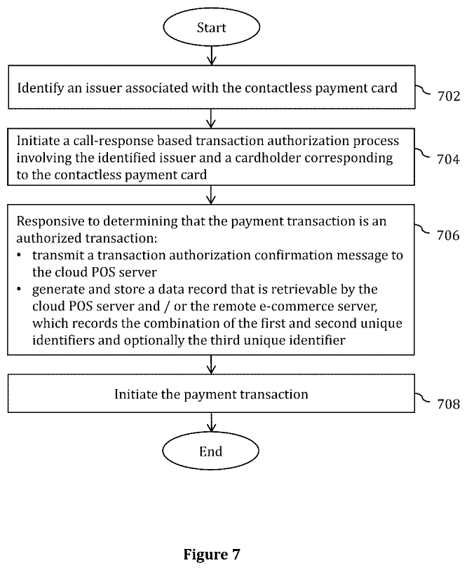

FIG. 7 is a flowchart illustrating a first embodiment of a method for implementing a second payment authorization communication flow within the method of FIG. 3. In an embodiment, the method of FIG. 7 is implemented in response to a determination at step 308 (of the method of FIG. 3) that the combination of the first unique identifier, the second unique identifier, and optionally the third unique identifier has not been previously recorded/mapped within a database of records that stores payment card identifiers, communication device identifiers (and optionally, user account identifier) for payment transactions that have been previously successfully authorized/authenticated/implemented. In an embodiment, the method of FIG. 7 is initiated at or implemented within cloud POS server 206,406.

Step 702 comprises identifying an issuer associated with the contactless payment card that has been detected at the contactless card tap event of step 502. The issuer associated with the contactless payment card may be identified by transmitting a lookup query message (e.g. a bank identification number (BIN) lookup query message) from cloud POS server 206, 406 to a lookup server. The lookup query may include the contactless payment card number or a payment account number associated with the contactless payment card—and the lookup server may use the contactless payment card number or the payment account number (or a part thereof) to identify from its records, an issuer that has issued the contactless payment card. The lookup server thereafter transmits a lookup response message to cloud POS server 206, 406, wherein the lookup response message includes data identifying the issuer that has issued the contactless payment card. The lookup server may in an embodiment be located within or communicably coupled with payment network 212.

Step 704 comprises initiating a call-response based transaction authorization/authentication process in connection with the requested payment transaction. The transaction authorization/authentication process may involve any transaction authorization/authentication process flow, including without limitation, a second-factor authentication process. In an embodiment, the call-response based transaction authorization/authentication process involves at least the following steps. For example, the call-response based transaction authorization/authentication process involves transmitting from the cloud POS server 206, 406 to the issuer associated with the contactless payment card, a transaction authorization request corresponding to the requested payment transaction, along with the contactless payment card number or a payment account number or any other unique identifier associated with the contactless payment card, the call-response based transaction authorization/authentication process involves initiating between as issuer server (i.e. a server associated with the issuer) and a card owner or cardholder that is authorized to operate or use the contactless payment card, a call-response based authorization/authentication process flow, for confirming whether the payment transaction for which authorization/authentication has been requested, has in fact been authorized by the card owner of card holder. The call-response based authorization/authentication process flow may include for example, any second factor authentication process flow involving the issuer server and a terminal device/mobile communication device associated with the card owner/card holder (for example, personal identification number based, one-time-password based, or static password based) authorization. Further, based on the results of the call-response based authorization/authentication process flow the call-response based transaction authorization/authentication process involves the issuer server determining whether the payment transaction is an authorized payment transaction or an unauthorized payment transaction.

At step 706, responsive to determining that the payment transaction is an authorized payment transaction, the issuer server transmits a transaction authorization confirmation message to the cloud POS server 206, 406, confirming that the requested payment transaction has been authorized. Further, the issuer server or the cloud POS server 406 (or any other server entity or computing entity) generates and stores a data record that is retrievable by the cloud POS server 205, 406 and/or by the concerned remote e-commerce server. The data record stores or maps the combination of the first and second unique identifiers and optionally the third unique identifier. The data record may be stored within a database of records that stores combinations of payment card identifiers, communication device identifiers (and optionally, user account identifiers) for payment transactions that have been previously successfully authorized/authentication/implemented.

Step 708 comprises initiating implementation of the payment transaction that has been triggered by the contactless card tap event detected at the communication device 206, 406 (i.e. at step 302 of the method of FIG. 3)—wherein implementation involves transfer of the transaction amount from a payment account associated with the contactless payment card to a beneficiary payment account (e.g. a payment account associated with or identified by the remote e-commerce server).

In the alternative, at step 706, responsive to determining that the payment transaction is not an authorized payment transaction, the payment transaction may be refused or rejected, and a notification of the refusal or rejection may be sent to one or more of cloud POS server 406, communication device 204, an issuer server, the remote e-commerce server and/or the card holder or card owner.

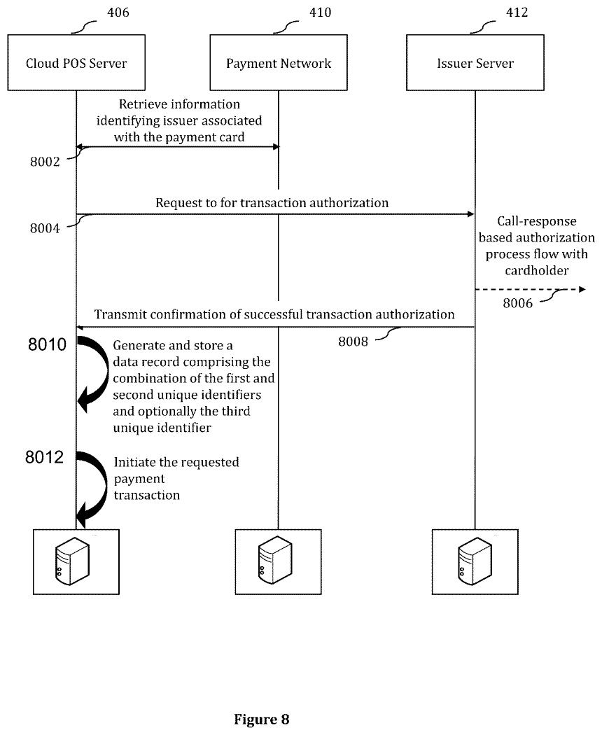

FIG. 8 is a communication flow diagram illustrating communication flow between system entities, for implementing the method of FIG. 7.

Step 8002 comprises cloud POS serve 406 retrieving information identifying a issuer associated with the contactless payment card, from payment network 410. The issuer associated with the contactless payment card may be identified by transmitting a lookup query message (e.g. a bank identification number (BIN) lookup query message) from cloud POS server 406 to payment network 410 (or to a lookup server within or communicably coupled with payment network 410). The lookup query may include the contactless payment card number or a payment account number associated with the contactless payment card—and the payment network 410 or the lookup server may use the contactless payment card number or the payment account number (or a part thereof) to identify from its records, an issuer that has issued the contactless payment card. The payment network 410 thereafter transmits a lookup response message to cloud POS server 406, wherein the lookup response message includes data identifying the issuer that has issued the contactless payment card.

Step 8004 comprises transmitting from cloud POS server 406 to an issuer server 412 (corresponding the issuer associated with the contactless payment card), a transaction authorization/authentication request, along with the contactless payment card number or a payment account number or any other unique identifier associated with the contactless payment card.

Issues server 412 responds to receipt of the transaction authorization/authentication request by initiating between the issuer server 412 and a card owner or cardholder that is authorized to operate or use the contactless payment card, a call-response based authorization/authentication process flow at step 8006. The call-response based authorization/authentication process flow enables confirmation whether payment transaction has in fact been authorized by the card owner of card holder. The call-response based authorization/authentication process flow may include for example, any second factor authorization process flow involving the issuer server and a terminal device/mobile communication device associated with the card owner/card holder (for example, personal identification number based, one-time-password based, or static password based) authorization.

Based on the results of the call-response based authorization/authentication process flow, the issuer server determines whether the payment transaction is an authorized payment transaction or as unauthorized payment transaction.

At step 8008, responsive to determining that the payment transaction is an authorized payment transaction, issuer server 412 transmits a transaction authorization confirmation message to the cloud POS server 406, continuing that the requested payment transaction has been authorized.

The cloud POS server 406 (or issuer server 412, or any other server entity or computing entity) at step 8010 generates and stores a data record that is retrievable by the cloud POS server 406 and/or by the concerned remote e-commerce server, which records or maps the combination of the first and second unique identifiers and optionally the third unique identifier. The data record may be stored within a database of records that stores combinations of payment card identifiers, communication device identifiers (and optionally, user account identifiers) corresponding to payment transactions that have been previously authorized or implemented.

The cloud POS server thereafter at step 8012 initiates implementation of the payment transaction that has been triggered by the contactless card tap event detected at the communication device (i.e. at step 302 of the method of FIG. 3).

FIG. 9 is a flowchart illustrating a second embodiment of a method for implementing a second payment authorization communication flow within the method of FIG. 3. In an embodiment, the method of FIG. 9 is implemented in response to a determination at step 308 (of the method of FIG. 3) that the combination of the first unique identifier, the second unique identifier, and optionally the third unique identifier has not been previously recorded/mapped within a database of records that stores payment card identifiers, communication device identifiers (and optionally, user account identifiers) for payment transactions that have been previously successfully authorized/authenticated/implemented. In an embodiment, the method of FIG. 9 is initiated at or implemented within cloud POS server 206, 406.

Step 902 comprises receiving from the communication device at which the card tap event has been detected at step 302 (e.g. communication device 204, 406), one or more card tap event parameters associated with the contactless card tap event. The card tap event parameters include any one or more of communication device motion parameter(s), location parameter(s), communication device velocity parameter(s), and location of the card tap event.

Communication device motion parameter(s) may identify information describing motion, movement and/or velocity or acceleration of the communication device. The communication device motion parameter(s) may be determined through one or more sensors located within the communication device including any of an accelerometer and a global-positioning-system (GPS) sensor. Communication device motion parameter(s) have been found to be determinative of whether a card tap event is a legitimate/authorized card tap event. In legitimate situations the communication device is typically static and the card tap event involves movement of the contactless payment card into NFC range of the communication device/POS terminal. On the other hand, in cases of fraudulent transactions, the contactless payment card is usually static, while the communication device is moved into NFC range of the contactless payment card—e.g. in a crowded place such as a bus or a metro train, where the contactless card is in the wallet or pocket of the card holder, and a communication device that has been prepared for an e-commerce transaction is surreptitiously brought within NFC range of the contactless payment card by an unauthorized person.

Location parameter(s) may identify the geo-location of the place where the card tap event has been detected. The location parameter(s) may be determined through one or more sensors located within the communication device, including a global-positioning-system (GPS) sensor, or through mobile tower triangulation, or any other method that would be apparent to the skilled person. Location parameter(s) have been found to be determinative of whether a card tap event is a legitimate/authorized card tap event. In legitimate situations the card tap event typically occurs in a location where previous authorized card tap events associated with the same contactless payment card have been detected. On the other hand, in cases of fraudulent transactions, the card tap event is often detected in unusual places where the card holder has not previously carried out a payment transaction using the same contactless card.

Communication device velocity parameter(s) may identify the speed or velocity of the communication device at the time of the detected card tap event. In case of fraudulent transactions that occur in moving vehicles such as a bus or a metro train (where the contactless card is in the wallet or pocket of the card holder, and a communication device that has been prepared for an e-commerce transaction is surreptitiously brought within NFC range of the contactless payment card by an unauthorized person), the velocity/speed of movement of the communication device in absolute terms (i.e. the velocity or speed owing to the movement of the vehicle itself) is significantly higher than the speed/velocity of a communication device in the case of normal/authorized transactions. Significant speed/velocity of a communication device at the time of the detected card tap event can therefore be used as a determinant of potential card fraud or card misuse.

The location of the card tap event may correspond to a specified delivery address associated with the payment transaction. It has been found that authorized card holders typically do not make a first-time card tap based transaction at a communication device that is located at any significant distance from the delivery address specified in connection with the e-commerce transaction that is being implemented. The location of the card tap event in relation to the specified delivery address can therefore also be used as a determinant of potential card fraud or card misuse.

Step 904 comprises generating, at a risk assessment server (for example, risk assessment server 208), a security assessment corresponding to the contactless card tap event, based on the received one or more card tap event parameters. In an embodiment, the security assessment generated at step 904 may comprise a risk score generated based on the one or more card tap event parameters received from the communication device 204, 404. In an embodiment, the security assessment comprises assigning or computing an individual risk score associated with each detected tap event parameter, and then using the plurality of risk scores to generate a security assessment.

In an embodiment, generating the security assessment is based on application or implementation of the following relationship:

$$log ( \frac{p}{1 - p} ) = \hat{α} + {\hat{β}}_{1} {X}_{1} + {\hat{β}}_{2} {X}_{2} + … + {\hat{β}}_{p} {X}_{p}$$

wherein ‘p’ represents the probability of fraud, and \hat{α}, \hat{β}₁, \hat{β}₂, . . . up to \hat{β}ₚ are the estimates of fraud coefficients for each of the different card tap event parameters.

Accordingly, for determining ‘p’ the following equation may be used:

$$p = \frac{{e}^{α + {β}_{1} {X}_{1} + {β}_{2} {X}_{2} + … + {β}_{p} {X}_{p}}}{1 + {e}^{α + {β}_{1} {X}_{1} + {β}_{2} {X}_{2} + … + {β}_{p} {X}_{p}}}$$

wherein ‘e’ is the exponential constant called euler's number, which is base of the natural logarithm—and has the approximately value 2.718.

In the above equation: α+β₁X₁+β₂X₂+ . . . +βₚXₚ=Intercept+(risk coefficient of first parameter*Parameter value)+(risk coefficient of second parameter*Parameter value)+(risk coefficient of third parameter*Parameter value).

As a result, an overall risk score can be generated based on the above equations and the card tap event parameters. If the overall risk score exceeds a predefined maximum risk score value, the security assessment is a negative security assessment comprising an assessment that the transaction is unsecure, or is likely to be a fraudulent transaction, or requires prior transaction authorization/authentication involving the issuer and/or the card holder. If the overall risk score is less than or equal to a predefined maximum risk score value, the security assessment is a positive security assessment comprising an assessment that the transaction is secure, or is likely to be a legitimate transaction, or that it does not require prior transaction authorization/authentication involving the issues and/or the card holder.

At step 906, responsive to the security assessment composing a positive security assessment, the risk assessment server 208 transmits a transaction authorization confirmation message to the cloud POS server 206, 406. Further, the cloud POS server 406 (or any other server entity or computing entity) generates and stores a data record that is retrievable by the cloud POS server 406 and/or by the concerned remote e-commerce server. The data record stores or maps the combination of the first and second unique identifiers and optionally the third unique identifier. The data record may be stored within a database of records that stores combinations of payment card identifiers, communication device identifiers (and optionally user account identifiers) for payment transactions that have been previously authorized or implemented.

Step 908 comprises initiating implementation of the payment transaction that has been triggered by the contactless card tap event detected at communication device 204, 404 (i.e. at step 302 of the method of FIG. 3)—wherein implementation involves transfer of the transaction amount from a payment account associated with the contactless payment card to a beneficiary payment account (e.g. a payment account associated with or identified by the remote e-commerce server).

In the alternative, at step 906, responsive to the security assessment comprising a negative security assessment (i) the payment transaction may be refused or rejected, and a notification of the refusal or rejection may be sent to one or more of cloud POS server 206, 406, communication device 204, 404, an issuer server, the remote e-commerce server and/or the card holder or card owner, or (ii) alternatively one or more verification process flows may be initiated for call-response based authorization/authentication of the payment transaction involving the issuer and/or the card owner or card holder.

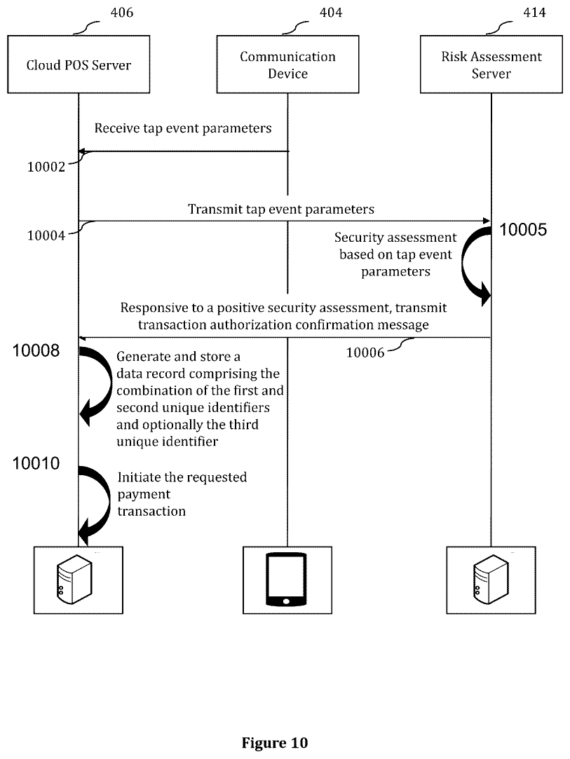

FIG. 10 is a communication flow diagram illustrating communication flow between system entities, for implementing the method of FIG. 9.

Step 10002 comprises receiving at cloud POS server 406 (from the communication device 404 at which the card tap event has been detected at step 302), one or more card tap event parameters associated with the contactless card tap event. The card tap event parameters may include any one or more of communication device motion parameter(s), location parameter(s), communication device velocity parameter(s), and a location of the card tap event.

The communication device motion parameter(s) may identify information describing motion, movement and/or velocity or acceleration of the communication device. The motion parameter(s) may be determined through one or more sensors located within the communication device, including any of as accelerometer and a global-positioning-system (GPS) sensor.

The location parameter(s) may identify the geo-location of the place where the card tap event has been detected. The location parameter(s) may be determined through one or more sensors located within the communication device, including a global-positioning-system (GPS) sensor, or through mobile tower triangulation, or any other method that would be apparent to the skilled person.

The communication device velocity parameter(s) may identify the speed or velocity of the communication device at the time of the detected card tap event.

The location of the card tap event may correspond to a specified delivery address associated with the payment transaction.

At step 10004, the cloud POS server 406 transmits the received card tap event parameters to risk assessment server 414.

Risk assessment server 414 generates at step 10005 a security assessment corresponding to the contactless card tap event, based on the received one or more card tap event parameters. In as embodiment, the security assessment generated by risk assessment server 414 may comprise a risk score generated based on the one or more card tap event parameters received from the cloud POS saver 406. The risk score may be generated in accordance with the detailed method steps described above in connection with step 9 of the method of FIG. 9.

At step 10006, responsive to the security assessment comprising a positive security assessment, risk assessment server 414 transmits a transaction authorization confirmation message to the cloud POS server 406. Thereafter, the cloud POS server 406 (or any other server entity or computing entity) at step 10008 generates and stores a data record that is retrievable by the cloud POS sever 406 and/or by the concerned remote e-commerce server. The data record stores or maps the combination of the first and second unique identifiers and optionally the third unique identifier. The data record may be stored within a database of records that stores combinations of payment card identifiers, communication device identifiers (and optionally user account identifiers) for payment transactions that have been previously authorized or implemented.

Cloud POS server 406 thereafter at step 10010 initiates implementation of the payment transactions that has been triggered by the contactless card tap event detected at the communication device 204, 404 (i.e. at step 302 of the method of FIG. 3).

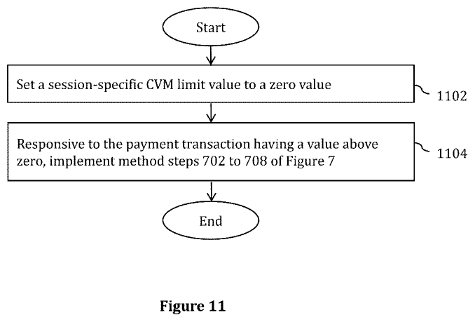

FIG. 11 is a flowchart illustrating a preferred embodiment of the method of FIG. 7.

The method of FIG. 11 is implemented in response to a determination at step 308 (of the method of FIG. 3) that the combination of the first unique identifier, the second unique identifier and optionally the third identifier has not been previously recorded/mapped within a database of records that records combinations of payment card identifiers, communication device identifiers (and optionally, user account identifiers) for payment transactions that have been previously successfully authorized/authenticated/implemented. In an embodiment, the method of FIG. 11 is initiated at or implemented within cloud POS server 406.

Step 1102 comprises assigning a zero value to a session-specific CVM limit associated with an NFC communication session that has been initiated by the card tap event detected at communication device 204. A CVM limit associated with a payment transaction is a monetary limit above which all payment card based transactions necessarily require implementation of a transaction authorization/authentication process flow (for example, second factor authentication). Payment transactions that are below the CVM limit can be carried out without implementation of a transaction authorization/authentication process flow (for example, second factor authentication). By setting a zero value session-specific CVM limit associated with the detected card tap event, the method ensures that no matter what the actual transaction value is, a transaction authorization/authentication process flow is necessarily required to be implemented. This is for the reason that, at step 308 (of the method of FIG. 3), it has been found that the combination of the first unique identifier, the second unique identifier, and optionally the third identifier has not been previously recorded/mapped within a database of records that records payment card identifiers, terminal device identifiers (and optionally, user account identifiers) for payment transactions that have been previously authorized through the cloud POS server 406.

Additionally, by making sure that a zero value is assigned to a session-specific CVM limit (and not to a CVM limit associated with the communication device 204, 404 or with the cloud POS sever 206, 406 or with the e-commerce server), the default CVM limit continues to apply generally, and a CVM limit of zero is only assigned for specific payment transactions where it has already been determined that the combination of the first unique identifier, the second unique identifier, and optionally the third identifier has not been previously recorded/mapped within a database of records that stores payment card identifiers, communication device identifiers (and optionally, user account identifiers) for payment transactions that have been previously successfully authorized/authenticated/implemented.

Thereafter, at step 1104, responsive to the payment transaction having a non-zero value (i.e. a valve above the assigned zero value CVM limit), one or more of method steps 702 to 708 as described in connection with the method of FIG. 7 are implemented.

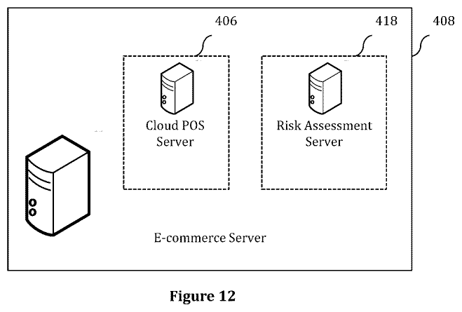

FIG. 12 illustrates a first configuration of system components that may be implemented within the system environment of FIG. 2, for implementing the teachings of the present invention. In this first configuration, each of cloud POS server 406 and risk assessment server 418 are implemented within server 408 that is associated with the software application implemented within communication device 204, and which is responsible for enabling the contactless payment transactions between the communication device 204 and e-commerce server 408. As a result, any communication or messages between communication device 204 and cloud POS server 406 would be routed through an interface within e-commerce server 408.

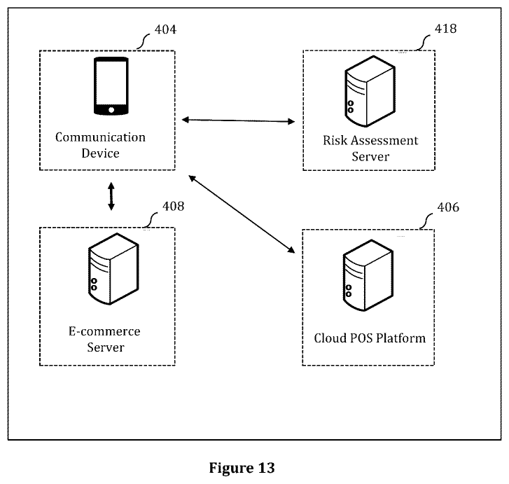

FIG. 13 illustrates a second configuration of system components that may be implemented within the system environment of FIG. 2, for implementing the teachings of the present invention.

In this second configuration, each of e-commerce server 408, cloud POS server 406 and risk assessment server 418 are implemented independently of or remotely to each other. As a result, in this embodiment, each of e-commerce server 408, cloud POS server 406, risk assessment server 418, and the software application implemented within communication device 204 (which is responsible for enabling the contactless payment transactions between the communication device 204 and e-commerce server 408), are capable of communicating directly with any one or more of the others, and do not require to have communications or messages routed between a centralized interface within e-commerce server 408.

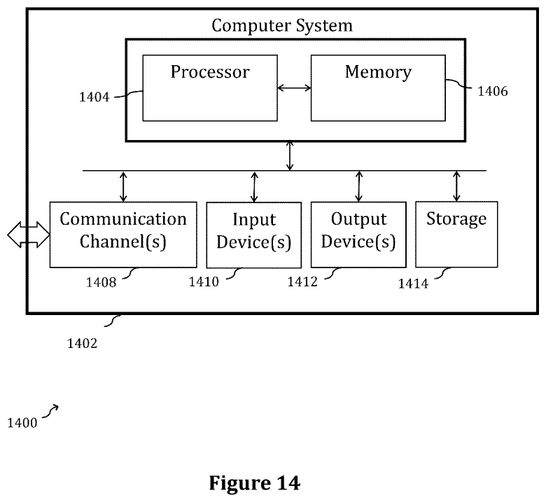

FIG. 14 illustrates an exemplary computer system 1400 according to which various embodiments of the present invention may be implemented.

System 1400 includes computer system 1402 which in turn comprises one or more processors 1404 and at least one memory 1406. Processor 1404 is configured to execute program instructions—and may be a real processor or a virtual processor. It will be understood that computer system 1402 does not suggest any limitation as to scope of use or functionality of described embodiments. The computer system 1402 may include, but is not limited to, one or more of a general-purpose computer, a programmed microprocessor, a micro-controller, an integrated circuit, and other devices or arrangements of devices that are capable of implementing the steps that constitute the method of the present invention. Exemplary embodiments of a computer system 1402 in accordance with the present invention may include one or more servers, desk tops, laptops, tablets, smart phones, mobile phones, mobile communication devices, phablets and personal digital assistants. In an embodiment of the present invention, the memory 1406 may store software for implementing various embodiments of the present invention. The computer system 1402 may have additional components. For example, the computer system 1402 may include one or more communication channels 1408, one or more input devices 1410, one or more output devices 1412, and storage 1414. An interconnection mechanisms (not shown) such as a bus, controller, or network, interconnects the components of the computer system 1402. In various embodiments of the present invention, operating system software (not shown) provides an operating environment for various softwares executing in the computer system 1402 using a processor 1404, and manages different functionalities of the components of the computer system 1402.

The communication channel(s) 1408 allow communication over a communication medium to various other computing entities. The communication medium provides information such as programs instructions, or other data in a communication media. The communication media includes, but is not limited to, wired or wireless methodologies implemented with an electrical, optical, RF, infrared, acoustic, microwave, Bluetooth or other transmission media.

The input device(s) 1410 may include, but is not limited to, a touch screen a keyboard mouse, pen, joystick, trackball, a voice device, a scanning device, or any another device that is capable of providing input to the computer system 1402. In an embodiment of the present invention, the input device(s) 1410 may be a sound card or similar device that accepts audio input in analog or digital form. The output device(s) 1412 may include, but not be limited to, a user interface on CRT, LCD, LED display, or any other display associated with any of servers, desktops, laptops, tablets, smart phones, mobile phones, mobile communication devices, phablets and personal digital assistants, printer, speaker, CD/DVD writer, or any other device that provides output from the computer system 1402.

The storage 1414 may include, but not be limited to, magnetic disks, magnetic tapes, CD-ROMS, CD-RWs, DVDs, any types of computer memory, magnetic shapes, smart cards, printed barcodes or any other transitory or non-transitory medium which can be used to store information and can be accessed by the computer system 1402. In various embodiments of the present invention, the storage 1414 may contain program instructions for implementing any of the described embodiments.

In an embodiment of the present invention, the computer system 1402 is part of a distributed network or a part of a set of available cloud resources.

The present invention may be implemented in numerous ways including as a system, a method, or a computer program product such as a computer readable storage medium or a computer network wherein programming instructions are communicated from a remote location.

The present invention may suitably be embodied as a computer program product for use with the computer system 1402. The method described herein is typically implemented as a computer program product, comprising a set of program instructions that is executed by the computer system 1402 or any other similar device. The set of program instructions may be a series of computer readable codes stored on a tangible medium, such as a computer readable storage medium (storage 1414), for example, diskette, CD-ROM, ROM, flash drives or hard disk, or transmittable to the computer system 1402, via a modem or other interface device, over either a tangible medium, including but not limited to optical or analogue communications channel(s) 1408. The implementation of the invention as a computer program product may be in an intangible form using wireless techniques, including but not limited to microwave, infrared, Bluetooth or other transmission techniques. These instructions can be preloaded into a system or recorded on a storage mediums such as a CD-ROM, or made available for downloading over a network such as the Internet or a mobile telephone network. The series of computer readable instructions may embody all or part of the functionality previously described herein.

Based on the above, it will be understood that the present invention provides solutions for securing contactless payment cards against misuse and unauthorized transactions at ‘unattended type’ terminal devices having near field communication capabilities. Among other forms of misuse, the invention secures contactless payment cards against instances of misuse where a communication device of the “unattended type” is surreptitiously brought within NFC communication range of a contactless payment card, without the knowledge of the cardholder, such that an NFC communication session is initiated between the contactless payment card and the communication device simply by the two objects being brought within communication range of each other.

While the exemplary embodiments of the present invention are described and illustrated herein, it will be appreciated that they are merely illustrative. It will be understood by those skilled in the art that various modifications in form and detail may be made therein without departing from or offending the spirit and scope of the invention as defined by the appended claims. Additionally the invention illustratively disclose herein suitably may be practiced in the absence of any element which is not specifically disclosed herein—and in a particular embodiment that is specifically contemplated, the invention is intended to be practiced in the absence of any one or more element which are not specifically disclosed herein.

1. A system for implementing a contactless payment card based payment transaction, the system comprising at least one processor implemented cloud POS server and configured to:
receive from a communication device:
a fact unique identifier associated with a contactless payment card; and
a second unique identifier associated with the communication device,
wherein the communication device has a software application implemented therein, and the software application is configured to implement payment transactions through a remote e-commerce server; and
wherein transmission of the first unique identifier and the second unique identifier from the communication device is implemented in response to:
the communication device detecting a contactless card tap event involving the contactless payment card and associated with a payment transaction being implemented between the software application and the remote e-commerce server; and
the communication device retrieving the first unique identifier from the contactless payment card; and
selectively implement one of a first payment authorization communication flow and a second payment authorization communication flow, wherein the selective implementation is based on a determination of whether a combination of the first unique identifier and the second unique identifier has been recorded within a database of records that stores combinations of payment card identifiers and communication device identifiers for payment transactions that have been previously successfully authorized.

2. The system of claim 1, wherein:
the first payment authorization communication flow is implemented in response to determining that the combination of the first unique identifier, the second unique identifier has been previously recorded within a database of records that stores combinations of payment card identifiers and communication device identifiers for payment transactions that have been previously successfully authorized; and
the first payment authorization communication flow comprises transmitting a payment instruction from the cloud POS server to a payment network for transaction implementation independent of additional transaction authorization or transaction authentication communication fours.

3. The system of claim 2, wherein transmitting the payment instruction from the cloud POS server to the payment network is preceded by verifying that a transaction value associated the payment transaction being implemented between the software application the remote e-commerce server is less that an defined card verification method (CVM) threshold value.

4. The system of claim 1, wherein:
the second payment authorization communication flow is implemented in response to determining that the combination of the first unique identifier, the second unique identifier has not been previously recorded within a database of records that stores combinations of payment card identifiers and communication device identifiers for payment that have been previously successfully authorized; and
the second payment authorization communication flow comprises:
triggering a transaction authorization communication flow or a transaction authentication communication flow; and
transmitting a payment instruction from the cloud POS server to a payment network for transaction implementation, in response to successful transaction authorization or transaction authentication.

5. The system of claim 4, wherein the second payment authorization communication flow comprises triggering the transaction authentication communication flow by:
receiving, from a lookup server, identification of an issuer associated with the contactless payment card;
transmitting, from the cloud POS server to an issuer server associated with the identified issuer, a transaction authorization request corresponding to the payment transaction, and any unique identifier associated with the contactless payment card;
receiving, from the issuer server, a transaction authorization confirmation message confirming that the payment transaction has been authorized, wherein the transaction authorization confirmation message is transmitted by the issuer server based on a result of a call-response based authorization or authentication involving a cardholder associated with the contactless payment card;
generating and storing, in the database of records, a data record associating the combination of the first and the second unique identifiers; and
initiating an implementation of the payment transaction, wherein the implementation involves a transfer of the transaction amount from a payment account associated with the contactless payment card to a beneficiary payment account.

6. The system of claim 4, wherein the second payment authorization communication flow comprises triggering the transaction authentication communication flow by:
receiving, from the communication device, one or more card tap event parameters associated with the contactless card tap event;
receiving, from a risk assessment server, a transaction authorization conformation message, wherein:
the transaction authorization confirmation message is transmitted by the risk assessment server based on a security assessment of the contactless card tap event, wherein the security assessment is generated at the risk assessment server based on the received one or more card tap event parameters; and
the transaction authorization confirmation message is transmitted by the risk assessment server in response to the security assessment comprising a positive security assessment;
generating and storing, in the database of records, a data record associating the combination of the first and the second unique identifiers; and
initiating an implementation of the payment transaction, wherein the implementation involves a transfer of the transaction amount from a payment account associated with the contactless payment card to a beneficiary payment account.

7. The system of claim 6, wherein the contactless card tap event parameters comprise one or more of:
one or more communication device motion parameters describing motion, movement, velocity or acceleration of the communication device; and
location parameters identifying the location of the card tap event.

8. The system of claim 5, wherein transmitting, from the cloud POS server to an issuer server associated with the identified issuer, the transaction authorization request corresponding to the payment transaction, and any unique identifier associated with the contactless payment card, is preceded by assigning a zero-value to a session-specific CVM threshold value associated with a near-field-communication session that has been initiated by the card tap event detected at the communication device.

9. A method for implementing a contactless payment card based payment transaction, the method, implemented with a processor implemented on a cloud POS server, comprising:
receiving from a communication device:
a first unique identifier associated with a contactless payment card; and
a second unique identifier associated with the communication device;
wherein the communication device has a software application implemented therein, and the software application is configured to implement payment transactions through a remote e-commerce server; and
wherein transmission of the first unique identifier and the second unique identifier from the communication device is implemented in response to:
the communication device detecting a contactless card tap event involving the contactless payment card and associated with a payment transaction being implemented between the software application and the remote e-commerce server; and
the communication device retrieving the first unique identifier front the contactless payment card; and
selectively implementing one of a first payment authorization communication flow and a second payment authorization communication flow, wherein the selective implementation is based on a determination of whether a combination of the first unique identifier and the second unique identifier has been recorded within a database of records that stores combinations of payment card identifiers and communication device identifiers for payment transactions that have been previously successfully authorized.

10. The method of claim 9, wherein:
the first payment authorization communication flow is implemented in response determining that the combination of the first unique identifier, the second unique identifier has been previously recorded within a database of records that stores combinations of payment card identifiers and communication device identifiers for payment transactions that have been previously successfully authorized; and
the first payment authorization communication flow comprises transmitting a payment instruction from the cloud POS server to a payment network for transaction implementation, independent of additional transaction authorization or transaction authentication communication flows.

11. The method of claim 10, wherein transmitting the payment instruction from the cloud POS server to the payment network is preceded by verifying that a transaction value associated the payment transaction being implemented between the software application the remote e-commerce server is less that an defined card verification method (CVM) threshold value.

12. The method of claim 9, wherein:
the second payment authorization communication flow is implemented in response to determining that the combination of the first unique identifier, the second unique identifier has not been previously recorded within a database of records that stores combinations of payment card identifiers and communication device identifiers for payment transactions that have been previously successfully authorized; and
the second payment authorization communication flow comprises:
triggering a transaction authorization communication flow or a transaction authentication communication flow; and
transmitting a payment instruction from the cloud POS server to a payment network for transaction implementation, in response to successful transaction authorization or transaction authentication.

13. The method of claim 12, wherein the second payment authorization communication flow comprises triggering a transaction authentication communication flow, comprising the steps of:
receiving, from a lookup server, identification of an issues associated with the contactless payment card;
transmitting, from the cloud POS server to an issuer server associated with the identified issuer, a transaction authorization request corresponding to the payment transaction, and any unique identifier associated with the contactless payment card;
receiving, from the issuer server, a transaction authorization confirmation message confirming that the payment transaction has been authorized, wherein the transaction authorization confirmation message is transmitted by the issuer server based on a result of call-response based authorization or authentication involving a cardholder associated with the contactless payment card;
generating and storing, in the database of records, a data record associating the combination of the first and the second unique identifiers; and
initiating an implementation of the payment transaction, wherein the implementation involves a transfer of the transaction amount from a payment account associated with the contactless payment card to a beneficiary payment account.

14. The method of claim 12, wherein the second payment authorization communication flow comprises triggering the transaction authentication communication flow by:
receiving, from the communication device, one or more card tap event parameters associated with the contactless card tap event;
receiving, from a risk assessment server, a transaction authorization communication message, wherein:
the transaction authorization confirmation message is transmitted by the risk assessment server based on a security assessment of the contactless card tap event, wherein the security assessment is generated at the risk assessment server based on the received one or more card tap event parameters; and
the transaction authorization confirmation message is transmitted by the risk assessment server in response to the security assessment comprising a positive security assessment;
generating and storing, in the database of records, a data record associating the combination of the first and the second unique identifiers; and
initiating an implementation of the payment transaction, wherein the implementation involves a transfer of the transaction amount from a payment account associated with the contactless payment card to a beneficiary payment account.

15. The method of claim 14, wherein the contactless card tap event parameters comprise one or more of:
one or more communication device motion parameters describing motion, movement, velocity or acceleration of the communication device; and
location parameters identifying the location of the card tap event.

16. The method of claim 13, wherein transmitting from the cloud POS server to an issuer server associated with the identified issuer, the transaction authorization request corresponding to the payment transaction, and any unique identifier associated with the contactless payment card, is preceded by assigning a zero-value to a session-specific CVM threshold value associated with a near-field-communication session that has been initiated by the card tap event detected at the communication device.

17. A computer program product for implementing a contactless payment card based payment transaction, comprising a non-transitory computer usable mediums having a computer readable programs code embodied therein, the computer readable program code comprising instructions to:
receive from a communication device:
a first unique identifier associated with a contactless payment card; and
a second unique identifier associated with the communication device;
wherein the communication device has a software application implemented therein, and the software application is configured to implement payment transactions through a remote e-commerce server; and
wherein transmission of the first unique identifier and the second unique identifier from the communication device is implemented in response to:
the communication device detecting a contactless card tap event involving the contactless payment card and associated with a payment transaction being implemented between the software application and the remote e-commerce server; and
the communication device retrieving the first unique identifier from the contactless payment card; and
selectively implement one of a first payment authorization communication flow and a second payment authorization communication flow, wherein the selective implementation is based on a determination of whether a combination of the first unique identifier and the second unique identifies has been recorded within a database of records that stores combinations of payment card identifiers and communication device identifiers for payment transactions that have been previously successfully authorized.

18. The computer program product of claim 17, wherein:
the first payment authorization communication flow is implemented in response to determining that the combination of the first unique identifier, the second unique identifier has been previously recorded within a database of records that stores combinations of payment card identifiers and communication device identifiers for payment transactions that have been previously successfully authorized; and
the first payment authorization communication flow comprises transmitting a payment instructions from the cloud POS server to a payment network for transaction implementation, independent of additional transaction authorization or transaction authentication communication flows.

19. The computer program product of claim 18, wherein transmitting the payment instruction from the cloud POS server to the payment network is preceded by verifying that a transaction value associated the payment transaction being implemented between the software application the remote e-commerce server is less that an defined card verification method (CVM) threshold value.

20. The computer program product of claim 17, wherein:
the second payment authorization communication flow is implemented in response to determining that the combination of the first unique identifier, the second unique identifier has not been previously recorded within a database of records that stores combinations of payment card identifiers and communication device identifiers for payment transactions that have been previously successfully authorized; and
the second payment authorization communication flow comprises:
triggering a transaction authorization communication flow or a transaction authentication communication flow; and
transmitting a payment instruction from the cloud POS server to a payment network for transaction implementation, in response to successful transaction authorization or transaction authentication.
